(19) United States
(12) Patent Application Publication
(10) Pub. No.: US 2026/0358993 A1
(43) Pub. Date: Nov. 12, 2026

(54) COMPUTING DEVICE FOR PERSONAL PLANNING

(71) Applicant: Kimberly Laurens, Portland, OR (US)

(72) Inventor: Kimberly Laurens, Portland, OR (US)

(21) Appl. No.: 19/201,532

(22) Filed: May 7, 2025

(51) Int. Cl. G06F 3/14; G06F 3/06

(52) U.S. Cl. CPC G06F 3/1423; G06F 3/0604; G06F 3/0655; G06F 3/0679

(57) ABSTRACT

A computing device for displaying data on display modules resembling pages of a book includes a spine body and a plurality of page modules coupled to one side of the spine body. Each page module comprises a display panel that is pivotably coupled to the spine body. The page modules may be arranged in a stacked configuration. Data storage readers are operatively coupled to a processor, and the processor is configured to cause each display panel to display data corresponding to a respective one of the data storage readers.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to computing devices and more particularly pertains to a new computing device for displaying data on display modules resembling pages of a book.

### (2) Description of Related Art including information disclosed under 37 CFR 1.97 and 1.98.

The prior art relates to computing devices in which display modules are arranged to resemble pages of a book. However, the prior art fails to describe such a device in which data read by multiple data storage readers is displayed on respective display modules of a plurality of page-like display modules.

### (h) BRIEF SUMMARY OF THE INVENTION

An embodiment of the disclosure meets the needs presented above by generally comprising a spine body. A top side and a bottom side of the spine body extends between a pair of ends of the spine body. An outer side and an inner side of the spine body extends between the top side and the bottom side of the spine body and between the pair of ends of the spine body. A plurality of page modules is coupled to the inner side of the spine member. The page modules are positionable in a stacked configuration. Each page module comprises a display panel which is pivotably coupled to the spine member. A processor is operatively coupled to the display panel of each page module of the plurality of page modules. A plurality of data storage readers is operatively coupled to the processor, and each data storage reader is configured to access data contained on a respective one of a plurality of data storage devices. The processor is configured to cause the display panel of each page module to display images corresponding to data read by a respective data storage reader of the plurality of data storage readers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a computing device according to an embodiment of the disclosure.

FIG. 2 is a side view of an embodiment of the disclosure.

FIG. 3 is a top view of an embodiment of the disclosure in a closed configuration and depicting an access door in a closed position.

FIG. 4 is a top view of an embodiment of the disclosure depicting an access door in an open position.

FIG. 5 is a top view of an embodiment of the disclosure in an open configuration.

FIG. 6 is an end view of an embodiment of the disclosure in a closed configuration.

FIG. 7 is an end view of an embodiment of the disclosure in an open configuration.

FIG. 8 is a block diagram of an embodiment of the disclosure.

### (j) DETAILED DESCRIPTION OF THE INVENTION

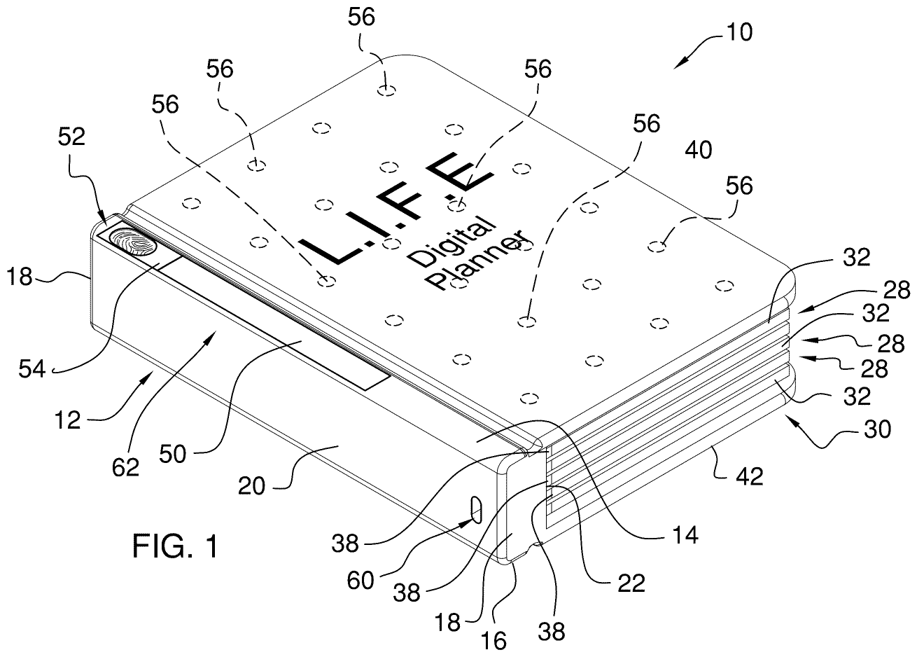

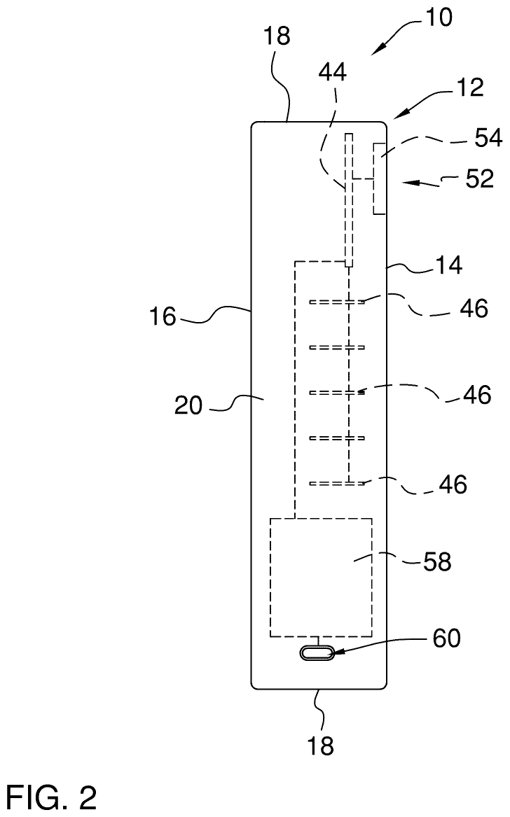

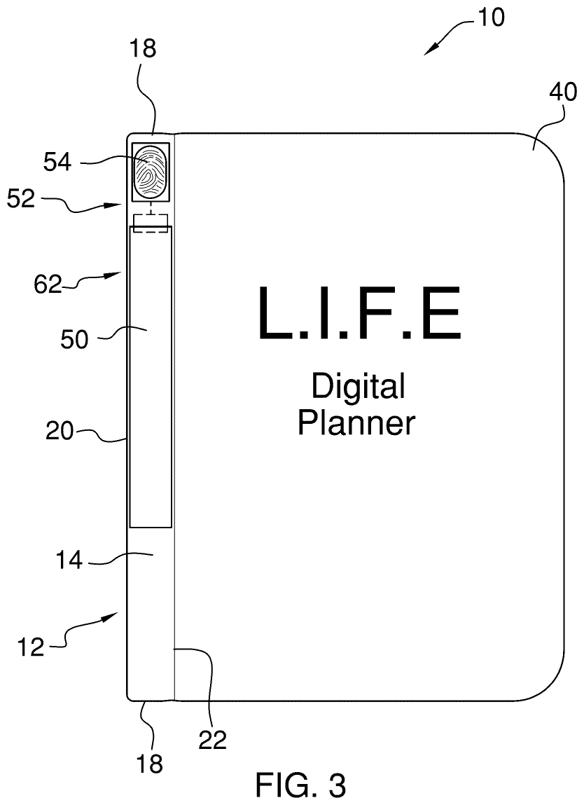

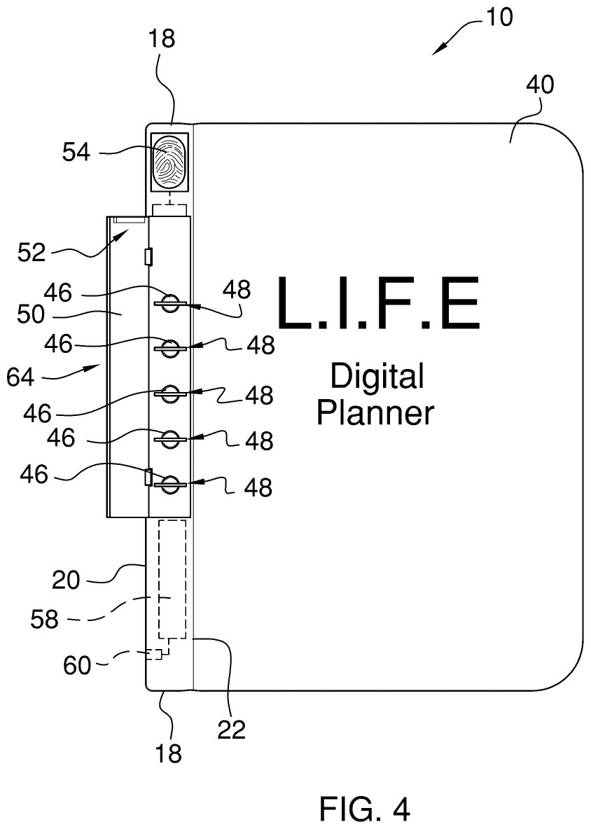

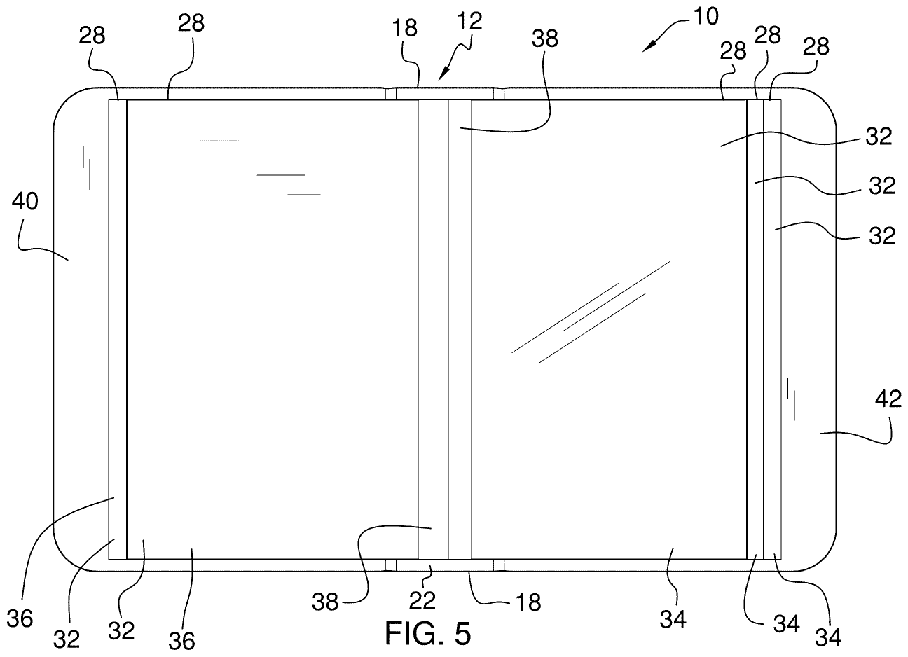

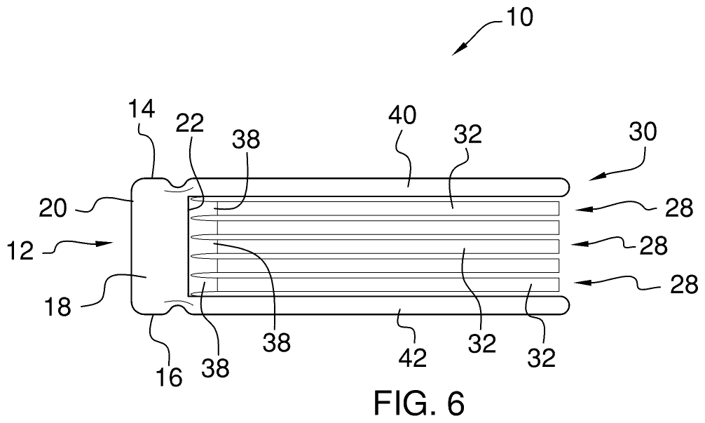

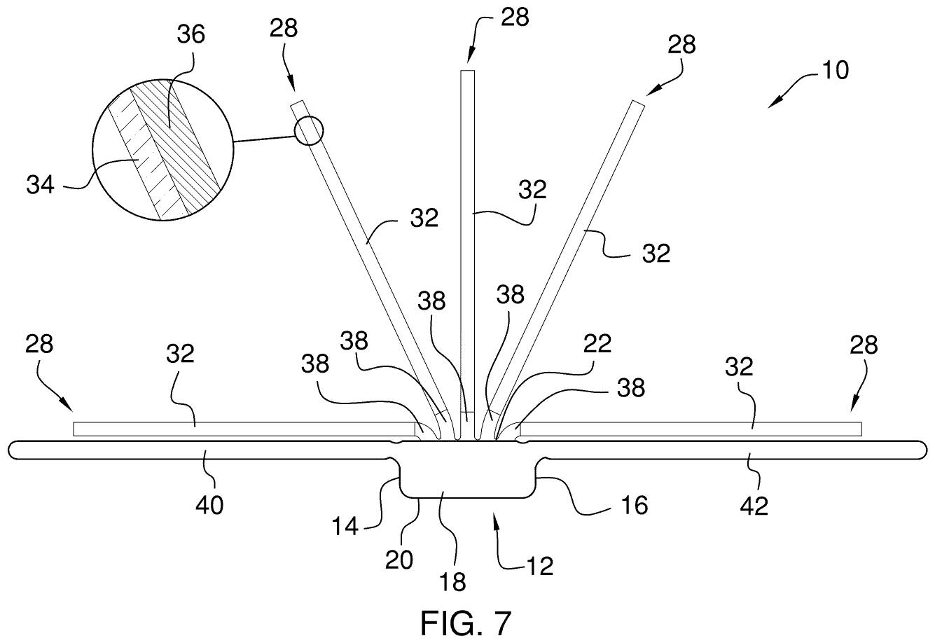

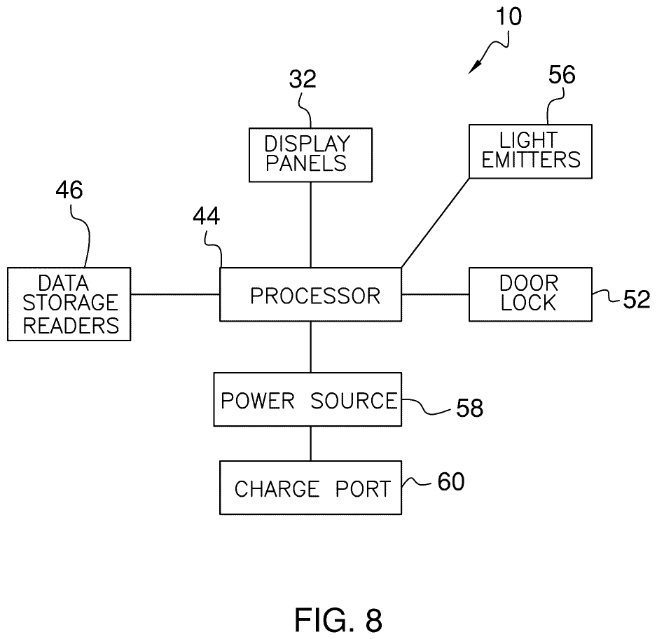

With reference now to the drawings, and in particular to FIGS. 1 through 8 thereof, a new computing device embodying the principles and concepts of an embodiment of the disclosure and generally designated by the reference numeral 10 will be described.

As best illustrated in FIGS. 1 through 8, the computing device 10 generally comprises components which are shaped and assembled to resemble a book. A spine body 12 is provided, wherein a top side 14 and a bottom side 16 of the spine body 12 extend between a pair of ends 18 of the spine body 12. An outer side 20 and an inner side 22 of the spine body 12 extend between the top side 14 and the bottom side 16 of the spine body 12 and between the pair of ends 18 of the spine body 12. The spine body 12 has an interior space 24 defined therein for housing various components further detailed below. A plurality of page modules 28 is coupled to the inner side 22 of the spine member. The plurality of page modules 28 is positionable in a stacked configuration 30 similar to pages of a book when the book is shut. A top cover panel 40 and a bottom cover panel 42 are also coupled to the inner side 22 of spine and are positioned opposite each other across the plurality of page modules 28.

Each page module 28 comprises a display panel 32 and an attachment member 38. The display panel 32 has a screen side 34 and a backing side 36, wherein the display panel 32 is configured to selectively display visual data which are visible on the screen side 34. The screen side 34 includes suitable display means such as a light-emitting diode screen, a projection device, an electronic paper device or the like. The backing may comprise any suitable material for mounting the display means and is typically opaque (though translucent or transparent materials may be used in some embodiments). The screen side 34 of the display panel 32 faces upwardly with respect to the spine body 12 when the page modules 28 are positioned in the stacked configuration 30. The display panel 32 of each page module 28 further comprises a touchscreen input.

The attachment member 38 is coupled to and extends between the display panel 32 and the spine body 12. The attachment member 38 pivotably couples the display panel 32 to the spine body 12. The attachment member 38 comprises a bendable material such as rubber, silicone, a suitable plastic, or the like. The attachment member 38 extends between the pair of ends 18 of the spine body 12. The display panel 32 may be rigid such that it does not appreciably bend during use. In this manner, only the attachment member 38 of each page module 28 typically bends to allow the page modules 28 to be leafed through. However, the display panel 32 may be bendable or flexible in other embodiments. In some embodiments, the attachment member 38 comprises a hinge or other pivot mechanism.

The top cover panel 40 and the bottom cover panel 42 are pivotably mounted to the spine body 12 via living hinges but may use other suitable hinge or pivot mechanisms. The top cover panel 40 and the bottom cover panel 42 may pivot alternately upwardly and downwardly with respect to the spine body 12 via the respective living hinges.

A processor 44 is mounted in the interior space 24 of the spine body 12 and is operatively coupled to the display panel 32 of each page module 28 of the plurality of page modules 28. The processor 44 is configured to perform various tasks as further described herein, which may be achieved via following non-transitory computer-readable instructions stored on a memory in communication with the processor 44 or may be achieved via physical structure of the processor 44.

The processor 44 is configured to display different visual data for the display panel 32 of each page module 28. For example, the display panel 32 of a first page module 28 of the plurality of page modules 28 may display personal and contact information and personal preferences for a user. A second page module 28 of the plurality of page modules 28 may display contact information for associates of the user and planner data. The planner data may include one or more calendars, a daily plan, and the like. A third page module 28 of the plurality of page modules 28 may display data corresponding to public environments such as measures of quantities of people in selected areas, densities of crowds in such selected areas, and the like. The data corresponding to public environments may also include routes of travel which avoid areas with higher quantities or densities of people. Such data may be obtained via communication of the processor 44 with other devices over the Internet or any other suitable communications network via suitable transceivers, wired connections, or the like.

A fourth page module 28 of the plurality of page modules 28 may display personalized recommendations for the user based on instructions followed by the processor 44. Personalized recommendations may include scheduling suggestions, reminders, and personal advice. The instructions for the processor 44 may be directed to alter the personalized recommendations over time in response to outcomes input by the user or monitored by the processor 44 via sensors. For example, if a scheduling suggestion which was followed by the user led to a negative outcome, the instructions may be programmed to provide a different scheduling suggestion during a future use of the instructions.

Various applications may be stored on a memory accessible by the processor 44 for displaying the various data described above on the display panels 32 of the page modules 28. Outputs displayed on the display panels 32 may change in response to inputs received by the touchscreen inputs of the display panels 32 or other input mechanisms.

A plurality of data storage readers 46 is mounted in the interior space 24 of the spine body 12 and is operatively coupled to the processor 44. Each data storage reader 46 is configured to access data contained on a respective one of a plurality of data storage devices. Each data storage reader 46 has a slot 48 for receiving the respective data storage device. The slot 48 of each data storage reader 46 is accessible through a top opening 26 of the spine body 12. The processor 44 is configured to cause the display panel 32 of each page module 28 to display images corresponding to data read by a respective data storage reader 46 of the plurality of data storage readers 46. The data storage readers 46 are memory card readers but may be flash drive readers, digital disk readers, or the like.

An access door 50 is movably mounted to the spine body 12 and is movable between an open position 64 and a closed position 62 with respect to the top opening 26 to selectively access the data storage readers 46. A door lock 52 is mounted to the spine body 12 and is operable to releasably lock the access door 50 in the closed position 62. The door lock 52 comprises a biometric interface for operating the door lock 52 which includes a fingerprint reader 54. Various other interfaces may be used for operating the door lock 52 in other embodiments, including a keyhole, a keypad, a card scanner, an eye scanner, or the like.

A light emission assembly is coupled to the top cover panel 40 and is operatively coupled to the processor 44. The light emission assembly comprises a plurality of light emitters 56 which are embedded in the top cover panel 40, and the top cover panel 40 comprises a material such that light from the light emitters 56 is viewable through the top cover panel 40. The material of the top cover panel 40 may be a glass, a plastic, or the like which is suitably transparent or translucent such that the light is perceivable through the top cover panel 40. The light emitters 56 may be operated by the processor 44 to emit a plurality of light patterns and may comprise multicolor lamps for producing light of various colors. The light emitters 56 may be used as indicators for reminders or other notifications for the user.

A power supply 58 is mounted in the interior space 24 of the spine body 12 and is electrically coupled to the processor 44. The power supply 58 comprises a battery but may comprise a capacitor or other suitable energy storage. A charge port 60 is mounted to the spine body 12 and is electrically coupled to the power supply 58.

In use, the touchscreen inputs of the display panels 32 may be manipulated to navigate different applications run by the processor 44. The applications may include non-transitory computer-readable instructions for accomplishing planning tasks or other personal management tasks. The display panels 32 of the different page modules 28 may display different data from each other as described above. Each data storage reader 46 is associated with only one respective page module 28 of the page modules 28 such that the processor 44 processes data for use from each data storage reader 46 only to display visual data only on the display module of the respective page module 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A computing device comprising:
a spine body, a top side and a bottom side of the spine body extending between a pair of ends of the spine body, an outer side and an inner side of the spine body extending between the top side and the bottom side of the spine body and between the pair of ends of the spine body;
a plurality of page modules coupled to the inner side of the spine member, the plurality of page modules being positionable in a stacked configuration, each page module of the plurality of page modules comprising a display panel pivotably coupled to the spine member;
a processor operatively coupled to the display panel of each page module of the plurality of page modules;
a plurality of data storage readers operatively coupled to the processor, each data storage reader of the plurality of data storage readers being configured to access data contained on a respective one of a plurality of data storage devices, the processor being configured to cause the display panel of each page module to display images corresponding to data read by a respective data storage reader of the plurality of data storage readers;
wherein the spine body has an interior space defined therein; and
wherein the plurality of data storage readers is mounted in the interior space of the spine body, each data storage reader of the plurality of data storage readers having a slot for receiving the respective data storage device, the slot of each data storage reader being accessible through a top opening of the spine body.

2. The computing device of claim 1, wherein the display panel of each page module has a screen side and a backing side, the display panel being configured to selectively display visual data which are visible on the screen side, the screen side of the display panel facing upwardly with respect to the spine body when the plurality of page modules is positioned in the stacked configuration.

3. The computing device of claim 1, wherein the display panel of each page module comprises a touchscreen input.

4. The computing device of claim 1, wherein each page module of the plurality of page modules further comprises an attachment member the attachment member being coupled to and extending between the display panel and the spine body, the attachment member pivotably coupling the display panel to the spine body.

5. The computing device of claim 4, wherein the attachment member of each page module comprises a bendable material, the attachment member extending between the pair of ends of the spine body.

6. The computing device of claim 1, further comprising a top cover panel and a bottom cover panel coupled to the inner side of the spine member, the top cover panel and the bottom cover panel being positioned opposite each other across the plurality of page modules, the top cover panel and the bottom cover panel being pivotable alternately upwardly and downwardly with respect to the spine body.

7. The computing device of claim 6, further comprising a light emission assembly coupled to the top cover and operatively coupled to the processor, the light emission assembly comprising a plurality of light emitters.

8. The computing device of claim 7, wherein the plurality of light emitters is embedded in the top cover.

9. The computing device of claim 7, wherein the plurality of light emitters is configured to emit a plurality of light patterns.

10. (canceled)

11. The computing device of claim 1, further comprising an access door movably mounted to the spine body, the access door being movable between an open position and a closed position with respect to the top opening.

12. A computing device comprising:
a spine body, a top side and a bottom side of the spine body extending between a pair of ends of the spine body, an outer side and an inner side of the spine body extending between the top side and the bottom side of the spine body and between the pair of ends of the spine body;
a plurality of page modules coupled to the inner side of the spine member, the plurality of page modules being positionable in a stacked configuration, each page module of the plurality of page modules comprising a display panel pivotably coupled to the spine member;
a processor operatively coupled to the display panel of each page module of the plurality of page modules;
a plurality of data storage readers operatively coupled to the processor, each data storage reader of the plurality of data storage readers being configured to access data contained on a respective one of a plurality of data storage devices, the processor being configured to cause the display panel of each page module to display images corresponding to data read by a respective data storage reader of the plurality of data storage readers;
an access door movably mounted to the spine body, the access door being movable between an open position and a closed position with respect to a top opening of the spine body; and
a door lock mounted to the spine body, the door lock being operable to releasably lock the access door in the closed position.

13. The computing device of claim 12, wherein the door lock comprises a biometric interface for operating the door lock.

14. The computing device of claim 13, wherein the biometric interface comprises a fingerprint reader.

15. The computing device of claim 1, further comprising:
a power supply mounted in the interior space of the spine body and electrically coupled to the processor, the power supply comprising a battery; and
a charge port mounted to the spine body and electrically coupled to the power supply.

16. A computing device comprising:
a spine body, a top side and a bottom side of the spine body extending between a pair of ends of the spine body, an outer side and an inner side of the spine body extending between the top side and the bottom side of the spine body and between the pair of ends of the spine body, the spine body having an interior space defined therein;
a plurality of page modules coupled to the inner side of the spine member, the plurality of page modules being positionable in a stacked configuration, each page module of the plurality of page modules comprising:
a display panel, the display panel having a screen side and a backing side, the display panel being configured to selectively display visual data which are visible on the screen side, the screen side of the display panel facing upwardly with respect to the spine body when the plurality of page modules is positioned in the stacked configuration, the display panel comprising a touchscreen input; and
an attachment member the attachment member being coupled to and extending between the display panel and the spine body, the attachment member pivotably coupling the display panel to the spine body, the attachment member comprising a bendable material, the attachment member extending between the pair of ends of the spine body;
a top cover panel and a bottom cover panel coupled to the inner side of the spine member, the top cover panel and the bottom cover panel being positioned opposite each other across the plurality of page modules, the top cover panel and the bottom cover panel being pivotable alternately upwardly and downwardly with respect to the spine body;
a processor mounted in the interior space of the spine body, the processor being operatively coupled to the display panel of each page module of the plurality of page modules, the processor being configured to display visual data on the display panels of the plurality of page modules, wherein the visual data of the display panels are different for each display panel;
a plurality of data storage readers mounted in the interior space of the spine body and operatively coupled to the processor, each data storage reader of the plurality of data storage readers being configured to access data contained on a respective one of a plurality of data storage devices, each data storage reader of the plurality of data storage readers having a slot for receiving the respective data storage device, the slot of each data storage reader being accessible through a top opening of the spine body, the processor being configured to cause the display panel of each page module to display images corresponding to data read by a respective data storage reader of the plurality of data storage readers;
an access door movably mounted to the spine body, the access door being movable between an open position and a closed position with respect to the top opening;
a door lock mounted to the spine body, the door lock being operable to releasably lock the access door in the closed position, the door lock comprising a biometric interface for operating the door lock, the biometric interface comprising a fingerprint reader;
a light emission assembly coupled to the top cover and operatively coupled to the processor, the light emission assembly comprising a plurality of light emitters, the plurality of light emitters being embedded in the top cover, the plurality of light emitters being configured to emit a plurality of light patterns;
a power supply mounted in the interior space of the spine body and electrically coupled to the processor, the power supply comprising a battery; and
a charge port mounted to the spine body and electrically coupled to the power supply.
